(19) United States
(12) Patent Application Publication
(10) Pub. No.: US 2015/0161138 A1
(43) Pub. Date: Jun. 11, 2015

(54) METHOD FOR RECOMMENDING DOCUMENT

(71) Applicant: RICHPLAY INFORMATION CO., LTD., NEW TAIPEI CITY (TW)

(72) Inventors: PEI-HSUN TSAI, NEW TAIPEI CITY (TW); JUN-HUI WU, NEW TAIPEI CITY (TW); CHAN-SAN LAUO, NEW TAIPEI CITY (TW); MIN-HSIUNG CHEN, NEW TAIPEI CITY (TW)

(21) Appl. No.: 14/554,567

(22) Filed: Nov. 26, 2014

(30) Foreign Application Priority Data
Dec. 5, 2013 (TW) 102144710

(51) Int. Cl. G06F 17/30

(52) U.S. Cl. CPC G06F 17/3053; G06F 17/30522

(57) ABSTRACT

A method for recommending document is revealed. First define that at least one first document is included in a first set by a first device and record that the first document is included in the first set by a first server connected to the first device. The association among document is recorded by the first device user' behavior to define the document is included in a specific set. Then the first server compares a second document with the first document when a second device connected to the first server defines that the second document is included in a second set. Once the second document matches the first document, the first server sends the rest first document to the second device so that associated document is recommended to the user of the second device actively.

### BACKGROUND OF THE INVENTION

1. Fields of the Invention

The present invention relates to a method for recommending document, especially to a method for recommending document that determines association among the document by recording the document included defined by various users and included in a specific set. Moreover, when a user triggers a comparison of another document and at least one document in the set, the rest documents in the same set is actively recommended to the user according to the association, or extra weighted interest scores.

2. Descriptions of Related Art

Along with civilization, people have learned more about the world and accumulated more knowledge at an exponential rate. Along with the larger base of knowledge, the time taken to double the knowledge is getting shorter. Some scholars diagrammed the explosion of knowledge in out day. Giving the accumulated knowledge from creation to the 1 century AD as a quantity of 1. It has doubled by 1750, and then doubled again by 1900, after 150 years. In the half century to 1950, the knowledge had doubled again. Then it has doubled again by 1960, and once again by 1967. The time required for doubling of the knowledge is shortened from a decade to 7 years. In the previous thirty years of 21 century, the new knowledge generated is over the knowledge accumulated over the past two thousand years. This rapid growth of knowledge is generally called “knowledge explosion.”

The term “The Explosion of Knowledge” comes from a book name written by American writer, Donald J. Hart, in 1960. The explosion of knowledge means the rapid increase in the amount and growth speed of the information, which is out of control. A common side effect of the explosion of knowledge is “information anxiety”. As the writer of the book “Information Anxiety”-Richard Saul Wurman said, information anxiety is produced by the ever-widening gap between what we understand and what we think we should understand. It is the black hole between data and knowledge, and it happens when information doesn't tell us what we want or need to know.

In order to reduce the information anxiety, to screen the useful information in advance is more effective than to absorb all the information as more as we can. Trying to absorb all the information is impractical in this era of “knowledge explosion”. One of the effective screening ways for users is to get the information the user may require by a recommendation mechanism. Thus the time the user required for searching and collecting the information is reduced. Take books as an example. An effective book recommendation tool helps users to set up practical reading lists quickly. Generally a system developer manually (or semi-automatically) classifies the books and sets up association among the books by human computing or keyword computing. Thus the book recommendation tool can actively provide users the associated books for their reference when users shows the interest in a book such as viewing information of the book, reading brief content of the book, reading book reviews from other readers, or adding the book into a read list or a wish list.

However, conventional book recommendation tool is quite relied on system developer's classification of books. This causes a heavy loading on the system developer or the system developer's classification may be quite different from the user's opinion. Thus there is room for improvement and a need to provide a novel method for recommending document. In the novel method, the classification of the books is no more relied on the system developer's classification of books. The book recommendation tool is involved in the user his own determination and classification. Thus the user can set up an association set that includes the associated document being determined by him. Thus the method can be used as a tool for managing the document. At the same time, the system records and compares the document in the association set established by each user so as to find out the document recorded repeatedly and set up an association model of document based on the user's determination. This association model of document can be modified dynamically by following set-up of association sets and inputting of the document into the set so as to ensure the accuracy of the associated document recommended by the tool.

Thus there is room for improvement and a need to provide a novel method for recommending document. A first device defines that at least one first document is included in a first set by a firs and a first server records that the first document is included in the first set while the first server is connected to the first device. The association among document is recorded by the first device user's behavior to define the document is included in a specific set. The association is used as a base for following determination. Then the first server compares a second document with the first document when a second device connected to the first server defines that the second document is included in a second set. Once the second document matches the first document, the first server sends the rest first document to the second device so that associated document is recommended to the user of the second device actively.

### SUMMARY OF THE INVENTION

Therefore it is a primary object of the present invention to provide a method for recommending document in which a server records that a plurality of pieces of document is included into a specific set according to a user's definition. When other users' definition triggers a comparison of a piece of document, the server finds out the set that includes the piece of document and recommends the rest document in the set to other users actively.

It is another object of the present invention to provide a method for recommending document by which users can determine and classify a plurality of pieces of associated document into a specific set. Thereby users can use the method to manage the document for following searching.

In order to achieve the above objects, a method for recommending document of the present invention is achieved by a first device and a second device, both connected to a first server. The method for recommending document includes following steps. First define that at least one piece of first document is included in at least one first set by a first device. A first server records that the first document is included in the first set. Then define that at least one piece of second document is included in at least one second set by a second device. The first server compares the second document with the first document. Then first server sends the rest first document in the first set to the second device when the second document matches the first document.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a schematic drawing showing relationship among components of an embodiment according to the present invention;

FIG. 1B is a flow chart showing steps of an embodiment according to the present invention;

FIG. 2A is a schematic drawing showing relationship among components of another embodiment according to the present invention;

FIG. 2B is a flow chart showing steps of another embodiment according to the present invention;

FIG. 3A is a schematic drawing showing relationship among components of a further embodiment according to the present invention;

FIG. 3B is a flow chart showing steps of a further embodiment according to the present invention.

### DETAILED DESCRIPTION OF THE PREFERRED

### Embodiment

Please refer to the following embodiments and detailed descriptions in order to learn features and functions of the present invention.

The present invention is a method for recommending document. A plurality of pieces of document is included into a specific set and recorded in a server according to a user's definition. When other users' definition triggers a comparison of a piece of document, the server finds out the set that includes the piece of document and recommends the rest document in the set to other users actively. The action that defines the pieces of document included in the specific set reflects user's determination about association of the document. Compared with conventional method for recommending document, the present invention provides users the document more close to their determination. Moreover, users can actively define a certain pieces of document included in a specific set by the present invention. Thus users can use the present invention as a tool to set up document lists.

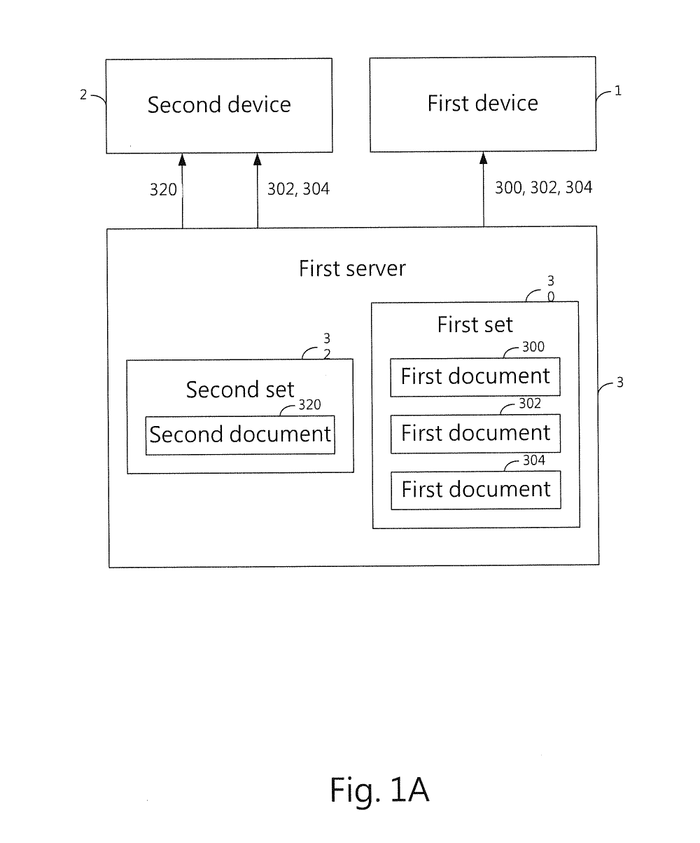

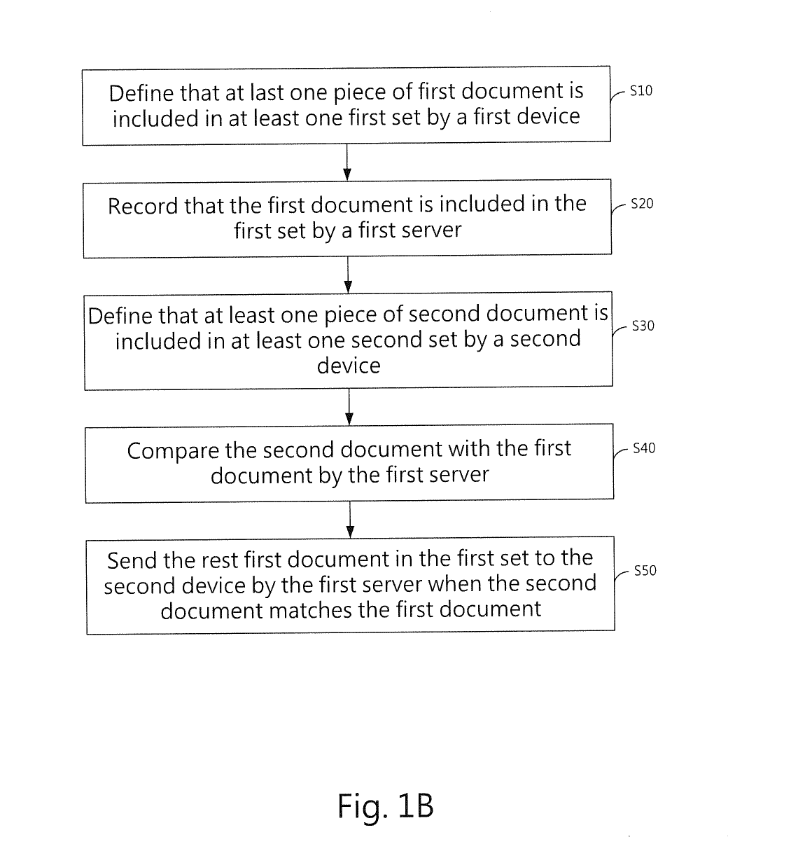

Refer to FIG. 1A and FIG. 1B, a method for recommending document of the present invention includes at least one first device 1, a second device 2 and a first server 3. The first device 1 and the second device 2 are connected to the first server 3 respectively. A first set 30 and a second set 32 are recorded in the first server 3. A plurality of pieces of first document 300, 302, and 304 is included in the first set 30 while a piece of second document 320 is included in the second set 32. In this embodiment, the respective first document 300, 302, and 304 or the second document 320 is information of a book and includes a book name, an author name, a name of publisher, table of contents, book preface, book introduction, a part of text in electronic form or full text in electronic form.

As shown in FIG. 1B, the method for recommending document of the present invention includes at least following steps:
Step S10: define that at last one piece of first document is included in at least one first set by a first device;
Step S20: record that the first document is included in the first set by a first server;
Step S30: define that at least one piece of second document is included in at least one second set by a second device;
Step S40: compare the second document with the first document by the first server; and
Step S50: send the rest first document in the first set to the second device by the first server when the second document matches the first document.

In this embodiment, the pieces of first document 300, 302, 304 and the second document 320 are stored in the first server 3. The first device 1 or the second device 2 can retrieve the pieces of the first document 300, 302, 304 or the second document 320 from the first server 3. In the step S10, a user that uses the first device 1 determines that the pieces of the first document 300, 302, 304 matches the same topic, then sets up the first set 30 in the first server 3 and defines that the pieces of the first document 300, 302, 304 is included in the first set 30. In the step S20, the first server 3 records that the pieces of the first document 300, 302, 304 is included in the first set 30 according to defining behavior of the first device 1.

By the step S10 and the step S20, the user of the first device 1 can perform the operation similar to “add to wish list” or “add to cart” for labeling respective first document he is interested in. Then the respective first document is further set into respective first set after being determined and classified by the user. For the user of the first device 1, the present invention can be used as a tool for creating document lists.

In the step S30, a user of the second device 2 sets up the second set 32 in the first server 3 and defines that the second document 320 is included in the second set 32. In the step S40, the first server 3 compares the second document 320 with various document in respective set recorded in the first server 3 according to defining behavior of the second device 2. The various document in respective set recorded in the first server 3 includes the pieces of the first document 300, 302, 304. In the step S50, the rest pieces of the first document 302, 304 in the first set 30 that includes the first document 300 therein are sent to the second vice 2 when the first server 3 determines that the second document 320 matches the first document 300.

By the step S30, the step S40 and the step S50, the first server 3 gets the first document 300 that matches the second document 320 from respective first document of respective first set established and defined by respective user when the user of the second device 2 determines and classifies the second document 320 into the second set 32. Then the rest first document in the first set 30 that includes the first document 300 is recommended to the user of the second device 2. If there is a plurality of first sets including the first document 300 that matches the second document 320, the first server 3 checks the number of repetitions of the rest first document in respective first set. The larger the number of repetitions, the more users determine that the rest first document is associated with the first document 300 (the second document 320). Thus the first server 3 gives higher priority to the rest first document repeated more often and provides them to the user of the second device 2. The rest first document repeated more often is more possible to meet the requirements of the user of the second device 2. For the user of the second device 2, the present invention can recommend him the rest first document (such as the pieces of the first document 302, 304) associated with the first document 300 so as to save time in finding out the document related to the first document 300 and setting the document into the second set 32 (used as a reading list or a wish list).

According to the steps 10 to 50 mentioned above, the method for recommending document of the present invention can be applied to the first server 3 for storing respective document and recoding respective set. Thus users can use the first server 3 as a tool for management of various document. At the same time, the association among respective document is obtained according to the determining behavior of the user during classification of the document. When other user puts a piece of document into a set himself defined, the associated document determined by previous user can be recommended actively.

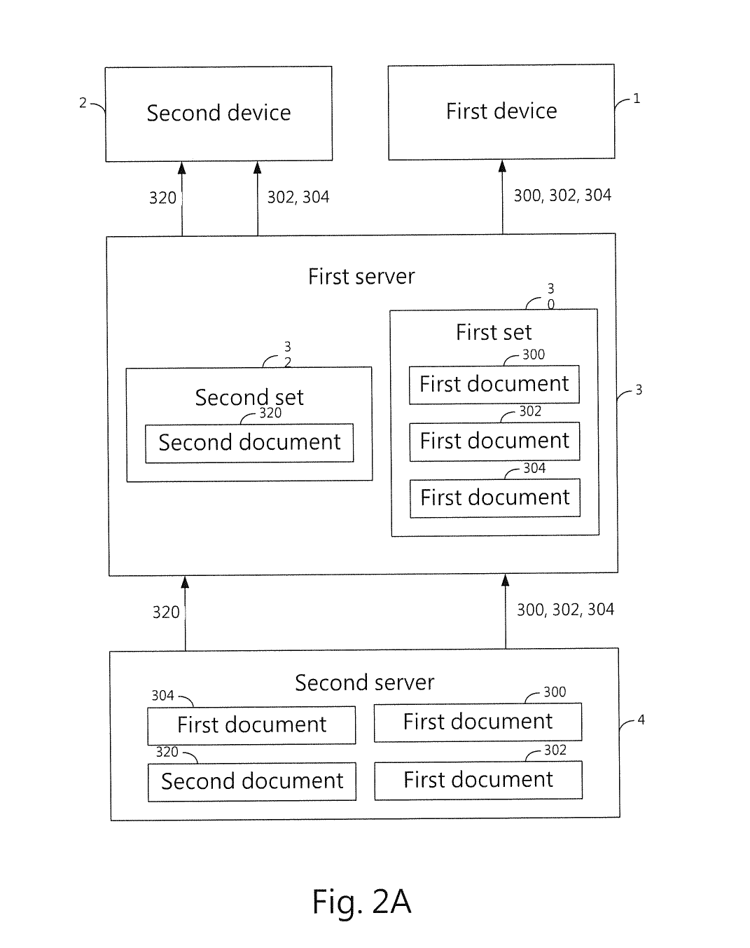

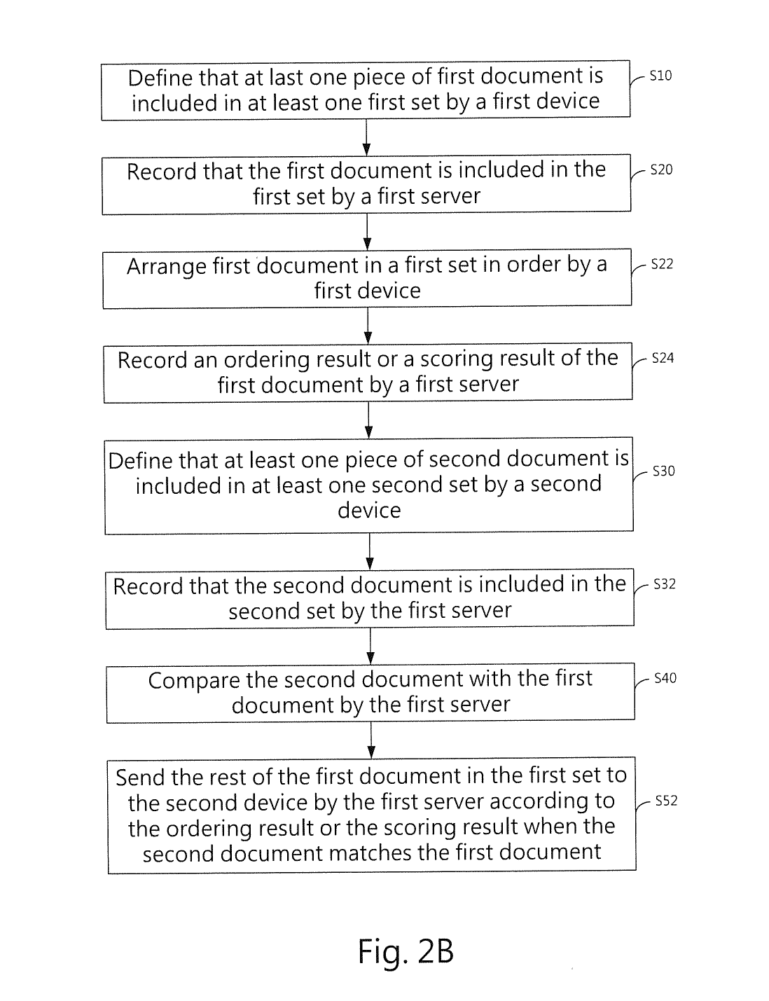

Refer to FIG. 2A and FIG. 2B, components and steps of another embodiment are disclosed. As shown in FIG. 2A, besides a first device 1, a second device 2 and a first server 1, the embodiment of the method for recommending document further includes a second server 4. A plurality of pieces of first document 300, 302, 304 and a piece of second document 320 are stored in the second server 4. The first device 1 and the second device 2 are connected to the first server 3 respectively and further to the second server 4 indirectly through the first server 3. A first set 30 and a second set 32 are recorded in the first server 3. A plurality of pieces of first document 300, 302, 304 is included in the first set 30 while a piece of second document 320 is included in the second set 32. As mentioned above, each of the first document 300, 302, and 304 or the second document 320 includes a book name, an author name, a name of publisher, table of contents, book preface, book introduction, a part of text in electronic form or full text in electronic form.

As shown in FIG. 2B, this embodiment further includes following steps between the step S20 and the step S30:
Step S22: arrange first document in a first set in order by a first device; and
Step S24: record an ordering result or a scoring result of the first document by a first server.

In the step S22, a user of the first device 1 determines the sequence of a plurality of pieces of first document 300, 302, 304 that is defined to be in the first set 30 by the first device 1 in the step S20. Then the first document 300 is arranged in an order of the first document 300, the first document 302, and the first document 304. 302, 304. In the step S24, the first server 3 records the ordering result of the first document 300, 302, 304 or converts the ordering result into a scoring result. Each piece of the first document is scored according to its order. For example, the last piece of the first document is scored 1, the second last piece of the first document is scored 2, and so on.

Moreover, this embodiment further modifies the step S50 of the above embodiment into the following step.
Step S52: send the rest of the first document in the first set to the second device by the first server according to the ordering result or the scoring result when the second document matches the first document.

In the step S52, when the first server 3 determines that the second document 320 matches the first document 300, the rest first document 302, 304 in the first set 30 that includes the first document 300 is sent to the second device 2 and recommended to the user of the second device 2 according to the ordering or the scoring result generated in the step S22 and recorded in the step S24.

By the step S22, the step S24 and the step S52, the first server 3 compares and gets the first document 300 that matches the second document 320 from respective first document in the respective first set established and defined by previous users when the user of the second device 2 determines and classifies the second document 320 into the second set 32. Then the rest first document in the first set 30 with the first document 300 is recommended to the user of the second device 2 according to the ordering result of the user of the first device 1. If there is a plurality of first sets including the first document 300 that matches the second document 320, the first server 3 checks the number of repetitions of the rest first document in respective first set, calculates the score of the rest first document in respective set according to the order, or calculates weighted score of the rest first document in respective set according to the number of repetitions. Then the rest first document is recommended to the user of the second device 2 in turn according to the calculation result.

Furthermore, this embodiment further includes the following step between the step S30 and the step S40:
Step S32: record that the second document is included in the second set by the first server.

In the step S32, the first server 3 records that the second document 320 is included in the second set 32 according to the defining behavior of the second device 2 in the step S30.

By the step S30 and the step S32, the user of the second device 2 can label respective second document he is interested in, similar to what the user of the first device 1 does in the step S10 and the step S20. Then the respective second document is further set into respective second set after being determined and classified by the user. For the user of the second device 2, the present invention can be used as a tool for creating respective document lists.

By the step S10 to the step S52 mentioned above, the method for recommending document of the present invention can be applied to the first server 3 worked as an intermediate between the first device 1/the second device 1 and the second server 4. The user can use the method of the present invention as a tool for management of document lists. Moreover, the association among respective document and the user ordering are obtained according to the association-checking and ordering behavior of the user during organization and classification of document. When other users use one piece of the document, the associated document determined by previous users is recommended according to user's preference.

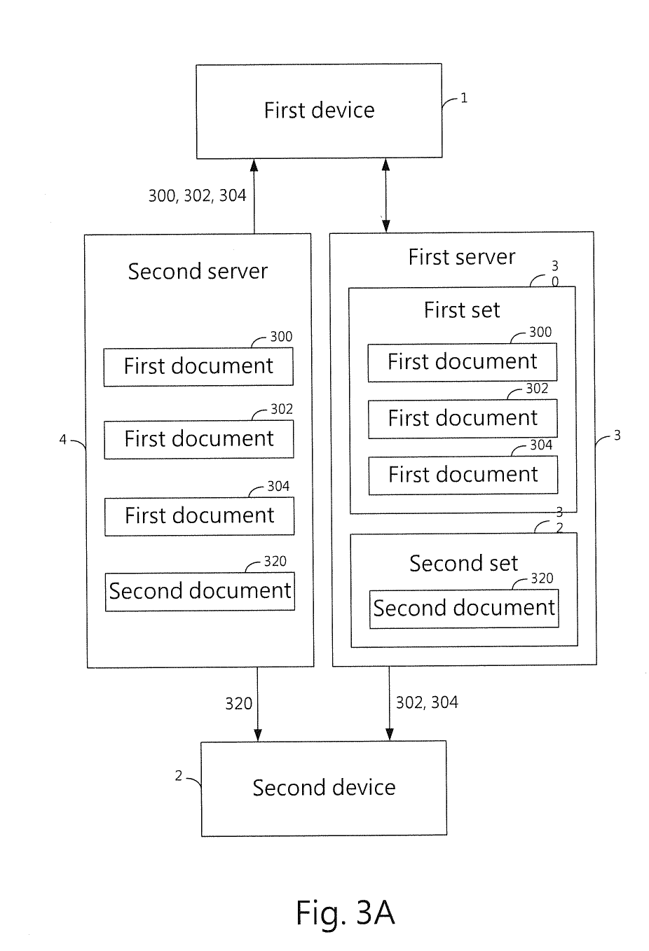

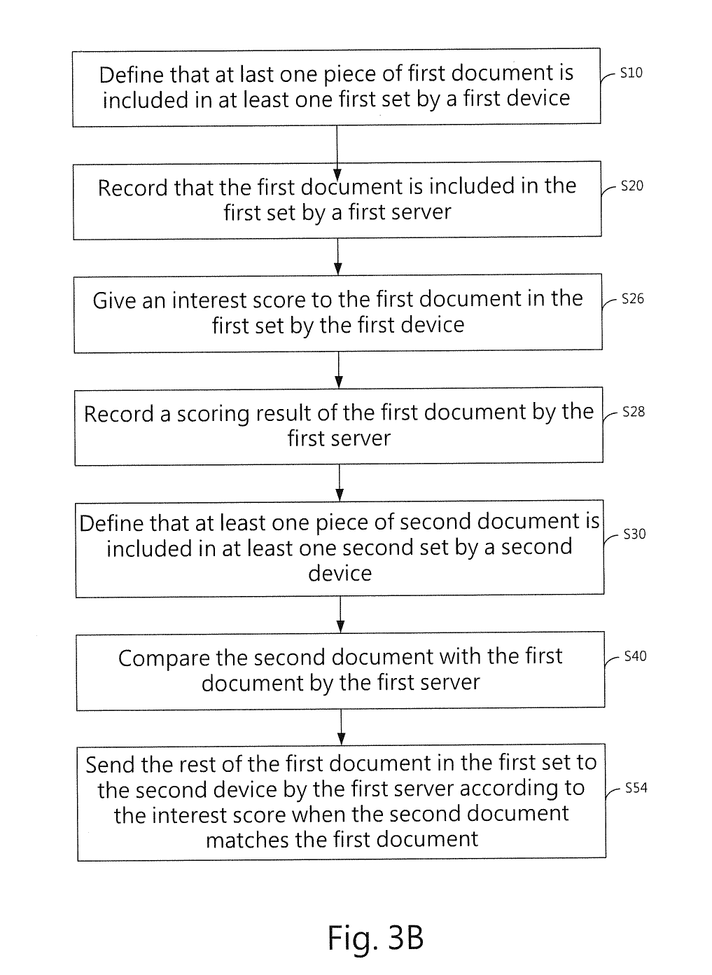

Refer to FIG. 3A and FIG. 3B, components and steps of a further embodiment are disclosed. As shown in FIG. 3A, besides a first device 1, a second device 2 and a first server 1, the embodiment of the method for recommending document further includes a second server 4. A plurality of pieces of first document 300, 302, 304 and a piece of second document 320 are stored in the second server 4. The first device 1 and the second device 2 are connected to both the first server 3 and the second server 4 respectively. A first set 30 and a second set 32 are recorded in the first server 3. A plurality of pieces of first document 300, 302, 304 is included in the first set 30 while a piece of second document 320 is included in the second set 32. As mentioned above, each of the first document 300, 302, and 304 or the second document 320 includes a book name, an author name, a name of publisher, table of contents, book preface, book introduction, a part of text in electronic form or full text in electronic form.

As shown in FIG. 3B, this embodiment further includes following steps between the step S20 and the step S30:
Step S26: give an interest score to the first document in the first set by the first device;
Step S28: record a scoring result of the first document by the first server.

In the step S26, a user of the first device 1 gives each piece of the first document 300, 302, 304 an interest score. The first document 300, 302, 304 is defined to be in the first set 30 by the first device 1 in the step S20. For example, the first document 300 is scored 10, the first document 302 is scored 8 and the first document 304 is scored 5. In the step S28, the first server 3 records the result of the interest scores of the first document 300, 302, 304.

Moreover, this embodiment further modifies the step S50 in the first embodiment into following step:
Step S54: send the rest of the first document in the first set to the second device by the first server according to the interest score when the second document matches the first document.

In the step S54, when the first server 3 determines that the second document 320 matches the first document 300, the rest first document 302, 304 in the first set 30 that includes the first document 300 is sent to the second device 2 according to the interest scores generated in the step S26 and recorded in the step S28. The rest first document 302, 304 is sent to the second device 2 and is recommended to the user of the second device 2 in an order of the first document 302 (with the interest score of 8) first and then the first document 304 (with the interest score of 5).

By the step S26, the step S28 and the step S54, the first server 3 compares the second document 320 with respective first document of respective first set established and defined by respective user so as to get the first document 300 that matches the second document 320 when the user of the second device 2 determines and classifies the second document 320 into the second set 32. Then the rest first document in the first set 30 that includes the first document 300 is recommended to the user of the second device 2 according to the scoring result of the user of the first device 1. If there is a plurality of first sets including the first document 300 that matches the second document 320, the first server 3 checks the number of repetitions of the rest first document in respective first set, calculates the interest score of the rest first document in respective set, or calculates weighted interest score of the rest first document in respective set according to the number of repetitions. Then the rest first document is recommended to the user of the second device 2 in turn according to the calculation result.

According to the step S10 to the step S54 mentioned above, the method for recommending document of the present invention can be applied to the condition that the first device 1 and the second device 2 are connected to both the first server 3 and the second server 4 respectively. And the present invention can be used as a tool for management of document lists. Moreover, the association among respective document and the user ordering are obtained according to the association-checking and ordering behavior of the user during organization and classification of document. When other users use one piece of the document, the associated document determined by previous users is recommended according to user's preference.

In summary, the method for recommending document of the present invention gets association among books and user's preference by users that classify document into specific sets, arrange the document in order or score the document according to the order. Moreover, the rest document included in the associated set is recommended to other users so as to save time the users require for searching information.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method for recommending document comprising the steps of:
defining that at least one piece of first document is included in at least one first set by a first device connected to a first server;
recording that the first document is included in the first set by the first server;
defining that at least one piece of second document is included in at least one second set by a second device connected to the first server;
comparing the second document with the first document by the first server; and
sending the rest first document in the first set to the second device by the first server when the second document matches the first document.

2. The method as claimed in claim 1, wherein between the step of recording that the first document is included in the first set by the first server and the step of defining that at least one piece of second document is included in at least one second set by a second device connected to the first server, the method further includes the steps of:
arranging the first document included in the first set in order by the first device; and
recording an ordering result of the first document by the first server.

3. The method as claimed in claim 2, wherein the first server sends the rest first document in the first set to the second device according to the ordering result of the first document.

4. The method as claimed in claim 2, wherein each piece of the first document is scored by the first server according to the ordering result to get a scoring result and then the rest first document in the first set is sent to the second device according to the scoring result.

5. The method as claimed in claim 1, wherein between the step of recording that the first document is included in the first set by the first server and the step of defining that at least one piece of second document is included in at least one second set by a second device connected to the first server, the method further includes the steps of:
giving an interest score to the first document in the first set by the first device; and
recording a scoring result of the first document by the first server.

6. The method as claimed in claim 5, wherein the first server sends the rest first document in the first set to the second device according to the interest score of the first document.

7. The method as claimed in claim 1, wherein between the step of defining that at least one piece of second document is included in at least one second set by a second device connected to the first server and the step of comparing the second document with the first document by the first server, the method further includes the step of:
recording the second document is included in the second set by the first server.
